(19) United States
(12) Patent Application Publication
(10) Pub. No.: US 2011/0227547 A1
(43) Pub. Date: Sep. 22, 2011

(54) Sensing capacitor for constant on-time and constant off-time switching regulators

(75) Inventors: Lik-Kin Wong, Tai Po (HK); Tze-Kau Man, Yuen Long (HK)

(73) Assignee: National Semiconductor Corporation, Santa Clara, CA (US)

(21) Appl. No.: 12/661,646

(22) Filed: Mar. 22, 2010

(51) Int. Cl. G05F 1/10

(52) U.S. Cl. 323/282

(57) ABSTRACT

A method includes generating an output voltage using a constant on-time or constant off-time (COT) switching regulator. The switching regulator includes a switch and an output capacitor. The method also includes sensing a first current flowing through a sensing capacitor, where the first current is proportional to a second current flowing through the output capacitor. The method further includes controlling the switch based on the sensed first current. Controlling the switch could include generating a feedback voltage using the sensed first current, combining the feedback and output voltages to generate a combined voltage, comparing a scaled version of the combined voltage and a reference voltage, and triggering a one-shot timer based on the comparison. A capacitance of the output capacitor may be greater than a capacitance of the sensing capacitor by a factor of N, and a transimpedance amplifier having a gain based on N could generate the feedback voltage.

### TECHNICAL FIELD

This disclosure is generally directed to switching regulators. More specifically, this disclosure relates to the use of a sensing capacitor for constant on-time and constant off-time switching regulators.

### BACKGROUND

Many systems use switching regulators to generate regulated voltages for use by other components of the systems. For example, a buck or step-down regulator generates an output voltage Vₒᵤₜ that is lower than its input voltage V_{IN}. A boost or step-up regulator generates an output voltage V_{OUT} that is higher than its input voltage V_{IN}.

Some switching regulators are controlled using constant on-time or constant off-time (COT) techniques. Using conventional COT techniques, one or more switches are turned on or off for a constant amount of time during each switching cycle, where the switches are used to generate the output voltage V_{OUT}. COT control techniques can provide various benefits depending on the implementation, such as a fast response time and a simple design.

Switching regulators that operate in this manner, however, can suffer from various problems. For example, some conventional COT regulators include either an output capacitor with a high equivalent series resistance (ESR) or a resistor coupled in series with a low-ESR output capacitor. While these approaches can provide good transient response, they allow large output voltage ripples to occur.

Another conventional COT regulator uses an RC network coupled across an inductor in the regulator. While this approach can reduce output voltage ripple, it increases the size and reduces the transient response of the regulator.

Still another conventional COT regulator places a resistor in series with a diode in the regulator, instead of in series with the output capacitor. In this approach, the COT regulator can measure the output current generated by the regulator. However, this approach can suffer from multiple pulsing effects at high output currents, require circuit elements to remove direct current (DC) components of the output currents, and require the use of a feedback capacitor.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example constant on-time or constant off-time (COT) switching regulator according to this disclosure;

FIGS. 2 and 3 illustrate example waveforms associated with the COT switching regulator of FIG. 1 according to this disclosure; and

FIG. 4 illustrates an example method for using a sensing capacitor in a COT switching regulator according to this disclosure.

### DETAILED DESCRIPTION

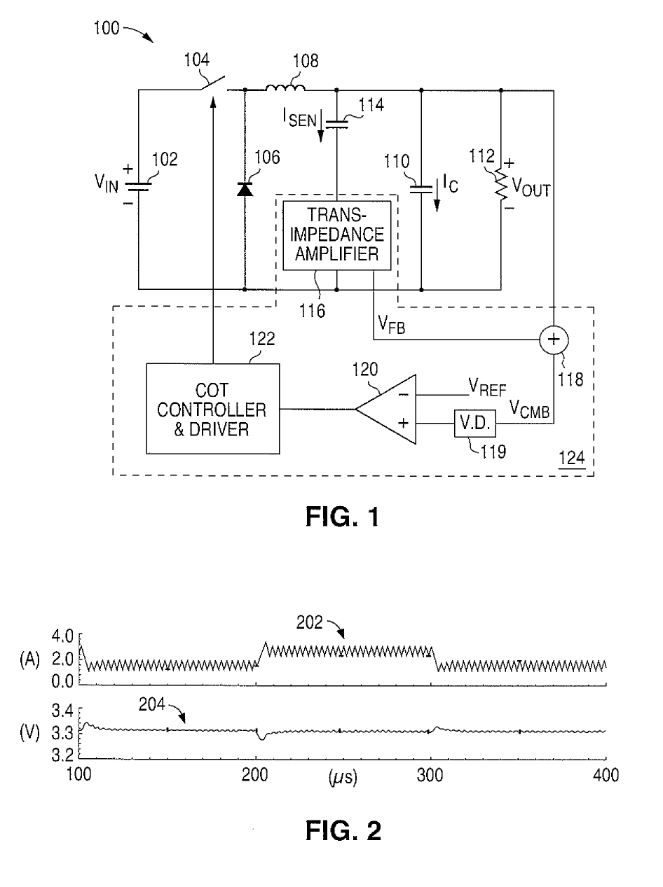

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example constant on-time or constant off-time (COT) switching regulator 100 according to this disclosure. In this example, the COT switching regulator 100 represents a buck converter that receives an input voltage V_{IN} and generates an output voltage V_{OUT}, which is less than the input voltage V_{IN}. This embodiment of the COT switching regulator 100 is for illustration only. Other embodiments of the COT switching regulator could be used without departing from the scope of this disclosure.

As shown in FIG. 1, the COT switching regulator 100 includes or is coupled to an input voltage source 102, which provides the input voltage V_{IN}. The input voltage source 102 represents any suitable structure that provides an input voltage, such as a battery.

The input voltage source 102 is coupled to a switch 104, which controls the application of the input voltage V_{IN} to other components in the regulator 100. For example, the switch 104 could be closed (made conductive) to couple the input voltage source 102 to other components of the regulator 100. The switch 104 could also be opened (made substantially or completely non-conductive) to block the input voltage V_{IN} from other components of the regulator 100. The switch 104 represents any suitable switching device, such as a power transistor.

The switch 104 is coupled to a diode 106 and an inductor 108. The diode 106 represents any suitable structure for substantially limiting current flow to one direction. Note that the diode 106 could be replaced by a switch that allows bi-directional current flow. The inductor 108 includes any suitable inductive structure having any suitable inductance. An output capacitor 110 is coupled to the inductor 108. The output capacitor 110 includes any suitable capacitive structure having any suitable capacitance. A load can receive and use the output voltage V_{OUT} generated by the regulator 100. The load in this example is represented by a resistance 112, which could have any suitable value.

As shown in FIG. 1, a sensing capacitor 114 and a transimpedance amplifier 116 are coupled in parallel across the output capacitor 110 and the load. The sensing capacitor 114 generally receives a sensing current I_{SEN} that is proportional to an output current I_{C} flowing through the output capacitor 110. The sensing current I_{SEN}, can represent a smaller scaled version of the output current I_{C}. The transimpedance amplifier 116 converts the sensing current I_{SEN}, to a corresponding feedback voltage V_{FB} and possibly amplifies the feedback voltage V_{FB}. The sensing capacitor 114 includes any suitable capacitive structure having any suitable capacitance. The transimpedance amplifier 116 includes any suitable structure for converting a current to a corresponding voltage. In some embodiments, the capacitance of the output capacitor 110 is greater than the capacitance of the sensing capacitor 114 by a factor of N, and the transimpedance amplifier 116 provides a gain that is some multiple (fractional or integer) of N. Also, in some embodiments, the capacitors 110 and 114 can have substantially the same temperature coefficients.

The feedback voltage V_{FB} generated by the transimpedance amplifier 116 is provided to a combiner 118. The combiner 118 combines the feedback voltage with the output voltage V_{OUT} to generate a combined voltage V_{CMB}. The combined voltage V_{CMB} can be provided to a voltage divider 119, which can scale the combined voltage V_{CMB}. The output of the voltage divider 119 can be compared to a reference voltage V_{REF} (such as 1.2V) by a comparator 120. The comparator 120 generates an output signal based on the comparison. The combiner 118 includes any suitable structure for combining signals. The voltage divider 119 includes any suitable structure for scaling a voltage, such as a resistive divider. The comparator 120 includes any suitable structure for comparing signals. The reference voltage V_{REF} could be provided by any suitable source, such as a bandgap voltage generator.

The output signal generated by the comparator 120 is provided to a COT controller and driver unit 122. The COT controller and driver unit 122 generates a drive signal for controlling operation of the switch 104. For example, the COT controller and driver unit 122 could generate a drive signal that turns the switch 104 on or off for a fixed amount of time during each of multiple switching cycles. The COT controller and driver unit 122 includes any suitable structure for controlling one or more switches in a COT switching regulator, such as a one-shot timer. A one-shot timer represents a circuit that, when activated, asserts a signal at a certain level for a specified amount of time. The one-shot timer could be triggered, for instance, whenever the scaled combined voltage V_{CMB} exceeds the reference voltage V_{REF}. The one-shot timer could be triggered once per switching cycle, where the switching cycle denotes the period of time between consecutive triggers (although other suitable events could be used to define the switching cycle).

In particular embodiments, the components 116-122 could be implemented within an integrated control circuit 124, such as a single integrated circuit (IC) chip. In these embodiments, the integrated control circuit 124 could include input/output pins or other structures that may be coupled to external components, such as the sensing capacitor 114 and the inductor 108. Note, however, that the components 116-122 could be implemented in any other suitable manner.

In the COT switching regulator 100 of FIG. 1, the sensing current I_{SEN} through the sensing capacitor 114 is measured or used, rather than the output current I_{C} through the output capacitor 110. The use of the sensing capacitor 114 therefore helps to avoid the need to measure the output current I_{C} directly. Since the current I_{SEN} through the sensing capacitor 114 may lack a DC component, this can also eliminate the need for circuit elements that filter DC components. It may also reduce or minimize the regulator's sensitivity to large output currents.

Moreover, since the transimpedance amplifier 116 is used instead of a standard resistance, the regulator 100 may reduce or eliminate multiple pulsing effects. Further, the regulator 100 can have stable operation even when a low-ESR output capacitor 110 is used without being coupled in series with a resistor. As a result, ceramic or other types of output capacitors can be used to reduce or minimize ripple in the output voltage V_{OUT}, which can increase the efficiency of the regulator 100. In addition, this approach can reduce the number of external components required in the regulator 100.

These benefits can be experienced while still obtaining the normal benefits associated with COT switching regulators. For example, the COT switching regulator 100 can still have a fast transient response, a good steady-state response, a simple design, and constant on/off time.

Although FIG. 1 illustrates one example of a COT switching regulator 100, various changes may be made to FIG. 1. For example, the functional division shown in FIG. 1 is for illustration only. Various components in FIG. 1 could be combined, further subdivided, or omitted and additional components could be added according to particular needs. As a particular example, while a buck converter is shown in FIG. 1, the regulator 100 could implement other switching converters, such as a boost, buck-boost, SEPIC, or flyback converter.

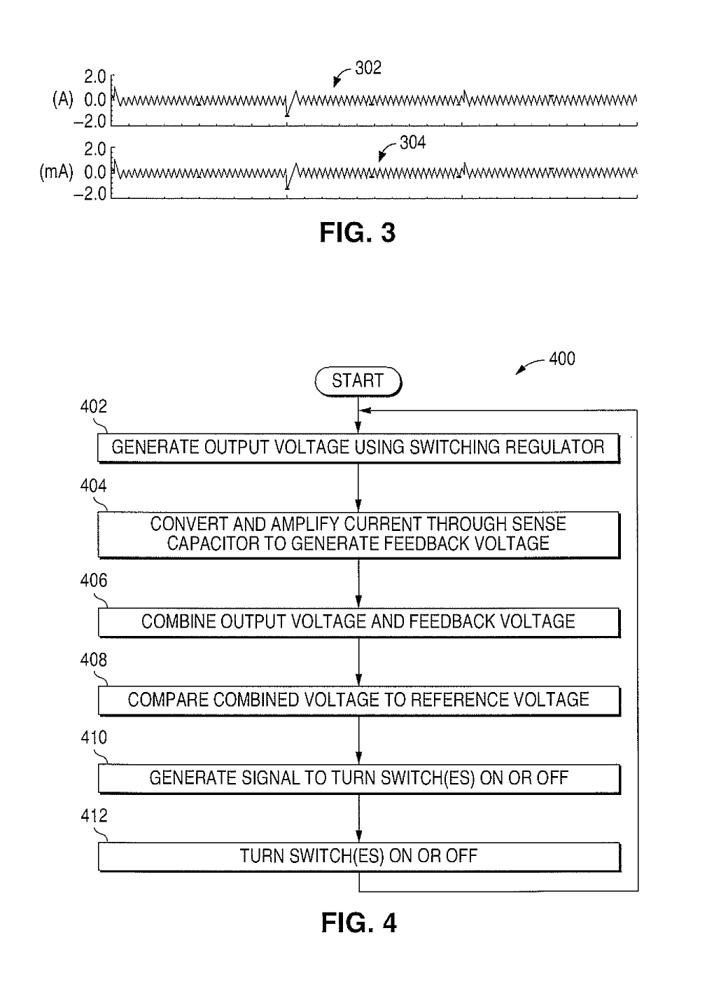

FIGS. 2 and 3 illustrate example waveforms associated with the COT switching regulator 100 of FIG. 1 according to this disclosure. In particular, FIG. 2 illustrates a waveform 202 that represents a simulated inductor current through the inductor 108 of the COT switching regulator 100. Also, the waveform 204 represents a simulated output voltage V_{OUT} of the COT switching regulator 100.

As shown in FIG. 2, the output voltage V_{OUT} suffers from a very small amount of output voltage ripple, approximately 5 mV in this example. A conventional COT switching regulator using a high-ESR output capacitor with a resistance of 50 mΩ could have a much larger output voltage ripple, such as 32 mV. Moreover, as shown in FIG. 2, the COT switching regulator 100 maintains a very fast load response. This illustrates that the COT switching regulator 100 can maintain a fast response time while significantly reducing output voltage ripple.

FIG. 3 illustrates waveforms 302-304 associated with simulated currents in the output and sensing capacitors 110 and 114 of the COT switching regulator 100. In this example, the waveform 302 represents a simulated current I_{C} through the output capacitor 110, and the waveform 304 represents a simulated current I_{SEN} through the sensing capacitor 114.

As shown in FIG. 3, the current I_{SEN} through the sensing capacitor 114 generally tracks the current I_{C} through the output capacitor 110. However, the current I_{SEN} through the sensing capacitor 114 is significantly smaller than the current I_{C} through the output capacitor 110. In this simulation, it is assumed that the ratio of the output capacitor's capacitance to the sensing capacitor's capacitance is 1000:1. This means the ratio of the output current I_{C} to the sensing current I_{SEN} is also 1000:1. This allows the COT switching regulator 100 to sense the output current I_{C} without creating multiple pulsing effects at high output currents. Moreover, the current I_{SEN} through the sensing capacitor 114 may lack DC components, so no additional components may be required to remove DC components from the sensing current I_{SEN}.

Although FIGS. 2 and 3 illustrate examples of waveforms associated with the COT switching regulator 100 of FIG. 1, various changes may be made to FIGS. 2 and 3. For example, these waveforms represent simulated operation of a particular implementation of the COT switching regulator 100. Other implementations of the COT switching regulator 100 could vary from the simulated operation shown here.

FIG. 4 illustrates an example method 400 for using a sensing capacitor in a COT switching regulator according to this disclosure. For ease of explanation, the method 400 is described with respect to the COT switching regulator 100 of FIG. 1. The method 400 could be used with any other suitable regulator, such as with a boost, buck-boost, SEPIC, or flyback converter.

As shown in FIG. 4, an output voltage is generated using a switching regulator at step 402. This could include, for example, generating the output voltage V_{OUT} by operating the switch 104 in the COT switching regulator 100. The generation of the output voltage V_{OUT} creates a current I_{C} through the output capacitor 110.

A current through a sense capacitor is converted and amplified at step 404. This could include, for example, the transimpedance amplifier 116 converting and amplifying a current I_{SEN} flowing through the sense capacitor 114 to generate a feedback voltage V_{FB}. The current I_{SEN} through the sense capacitor 114 could be a scaled replica of the current I_{C} through the output capacitor 110.

The output voltage is combined with the feedback voltage at step 406. This could include, for example, combining the feedback voltage V_{FB} and the output voltage V_{OUT} to generate the combined voltage V_{CMB}. The combined voltage is compared to a reference voltage at step 408. This could include, for example, the voltage divider 119 scaling the combined voltage V_{CMB} and the comparator 120 comparing the scaled combined voltage V_{CMB}, to the reference voltage V_{REF}.

A signal for turning one or more switches in the COT regulator on or off is generated at step 410, and the one or more switches in the COT regulator are turned on or off at step 412. This could include, for example, a one-shot timer in the COT controller and driver unit 122 triggering a pulse in a drive signal provided to the switch 104. The pulse could be triggered based on the comparison made during step 408, and the pulse can turn the switch(es) on or off for a constant amount of time. At this point, the method 400 repeats, where the output signal generated at step 402 is based (at least in part) on the switch 404 being turned on or off.

Although FIG. 4 illustrates one example of a method 400 for using a sensing capacitor in a COT switching regulator, various changes may be made to FIG. 4. For example, while shown as a series of steps, various steps in FIG. 4 may overlap, occur in parallel, or occur in a different order.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
generating an output voltage using a constant on-time or constant off-time (COT) switching regulator, the COT switching regulator comprising a switch and an output capacitor;
sensing a first current flowing through a sensing capacitor, the first current proportional to a second current flowing through the output capacitor; and
controlling the switch based on the sensed first current.

2. The method of claim 1, wherein controlling the switch based on the sensed first current comprises:
generating a feedback voltage using the sensed first current;
combining the feedback voltage and the output voltage to generate a combined voltage; and
controlling the switch based on the combined voltage.

3. The method of claim 2, wherein controlling the switch based on the combined voltage comprises:
comparing a scaled version of the combined voltage and a reference voltage; and
triggering a one-shot timer to generate a pulse in a drive signal for the switch based on the comparison.

4. The method of claim 2, wherein:
a capacitance of the output capacitor is greater than a capacitance of the sensing capacitor by a factor of N; and
the second current is greater than the first current by the factor of N.

5. The method of claim 4, wherein generating the feedback voltage comprises using a transimpedance amplifier having a gain based on N.

6. The method of claim 5, wherein the sensing capacitor and the transimpedance amplifier are coupled in parallel across the output capacitor.

7. The method of claim 1, wherein the COT switching regulator comprises a buck converter that receives an input voltage, the output voltage less than the input voltage.

8. An apparatus comprising:
a constant on-time or constant off-time (COT) switching regulator configured to generate an output voltage, the COT switching regulator comprising a switch and an output capacitor;
a sensing capacitor configured to receive a first current that is proportional to a second current through the output capacitor; and
a control circuit configured to sense the first current and to control the switch based on the sensed first current.

9. The apparatus of claim 8, wherein the control circuit comprises:
a transimpedance amplifier configured to generate a feedback voltage based on the sensed first current;
a combiner configured to combine the feedback voltage and the output voltage to generate a combined voltage to generate a combined voltage;
a voltage divider configured to generate a scaled version of the combined voltage;
a comparator configured to compare the scaled version of the combined voltage and a reference voltage; and
a control and driver unit configured to control the switch based on an output of the comparator.

10. The apparatus of claim 9, wherein the control and driver unit comprises a one-shot timer configured to generate a pulse in a drive signal for the switch based on the output of the comparator.

11. The apparatus of claim 9, wherein a capacitance of the output capacitor is greater than a capacitance of the sensing capacitor by a factor of N.

12. The apparatus of claim 11, wherein the transimpedance amplifier has a gain based on N.

13. The apparatus of claim 9, wherein the sensing capacitor and the transimpedance amplifier are coupled in parallel across the output capacitor.

14. The apparatus of claim 8, wherein the output capacitor comprises a ceramic capacitor.

15. The apparatus of claim 8, wherein the output capacitor and the sensing capacitor have substantially equal temperature coefficients.

16. The apparatus of claim 8, further comprising:
an inductor coupled on one side to the switch and coupled on another side to the output and sensing capacitors.

17. A circuit comprising:
a transimpedance amplifier configured to be coupled to a sensing capacitor, the transimpedance amplifier configured to generate a feedback voltage based on a first current through the sensing capacitor that is proportional to a second current through an output capacitor of a constant on-time or constant off-time (COT) switching regulator;
a combiner configured to combine the feedback voltage and an output voltage generated by the COT switching regulator to generate a combined voltage;
a voltage divider configured to generate a scaled version of the combined voltage;
a comparator configured to compare the scaled version of the combined voltage and a reference voltage; and
a control and driver unit configured to generate a drive signal for controlling a switch in the COT switching regulator based on an output of the comparator.

18. The circuit of claim 17, wherein the control and driver unit comprises a one-shot timer configured to generate a pulse in the drive signal based on the output of the comparator.

19. The circuit of claim 17, wherein:
a capacitance of the output capacitor is greater than a capacitance of the sensing capacitor by a factor of N; and
the transimpedance amplifier has a gain based on N.

20. The circuit of claim 17, wherein the transimpedance amplifier is configured to be coupled in series with the sensing capacitor and in parallel with the output capacitor.
